(19) United States
(12) Patent Application Publication
(10) Pub. No.: US 2007/0030955 A1
(43) Pub. Date: Feb. 8, 2007

(54) Scatter imaging system

(75) Inventors: Richard Franklin Eilbert, Lincoln, MA (US); Boris Oreper, Newton, MA (US); Nicholas Gillett, Redondo Beach, CA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: L-3 Communications Security and Detection Systems Inc., Woburn, MA (US)

(21) Appl. No.: 11/351,998

(22) Filed: Feb. 10, 2006

Related U.S. Application Data
(60) Provisional application No. 60/652,456, filed on Feb. 11, 2005.

(51) Int. Cl. G01N 23/201

(52) U.S. Cl. 378/87

(57) ABSTRACT

A radiation (e.g., X-ray) source and collimator assembly with no moving parts provides a swept-line scan of radiation suitable for imaging or analyzing radiation scattered from an object. Scatter radiation is sensed by (e.g., scintillation devices) to produce a signal which is then able to be processed to produce an image, or to be analyzed.

### CROSS-REFERENCE TO RELATED APPLICATIONS

This application claims the benefit, under 35 U.S.C. § 119(e), of the filing date of Feb. 11, 2005 of provisional patent application No. 60/652456, titled “Backscatter Imaging System.”

### FIELD OF THE INVENTION

This invention relates to the fields of security systems and imaging using X-rays and other suitable radiation. More particularly, it relates to a system for probing objects, including people, to detect hidden objects or materials including, but not limited to, weapons and explosives.

### BACKGROUND

There exist many situations in which non-destructive probing of objects is needed, such as to detect composition of an object, the presence or absence of an object or material within another object, or for other purposes. For example, the need exists to screen airline baggage and passengers and persons entering various facilities, for safety, security or other reasons. The screeners thus may be looking for the presence or absence of weapons, explosives or other materials or objects.

Several technologies exist for these purposes. Each has its pros and cons. Better, faster, less expensive and more versatile systems are constantly being sought and developed. By “better” is meant a system or technology that provides improved detection and/or classification of objects/materials. Speed, cost and reliability are key factors.

One of the technologies in use for inspection/probing of objects is the use of radiation such as (but not limited to) X-rays. X-ray detection systems have proven extremely useful not only for medical imaging, but also for baggage inspection, for example, and they have become ubiquitous for this purpose. In such systems, an X-ray source typically emits X-rays that pass through the article or object being inspected, to be detected on the opposite side of the object. From the transmission pattern of the X-rays, one can create an image of the interior of the object, differentiating portions of the object based on their apparent density to X-rays (i.e., the attenuation they produce).

When it is only desired to image the outside of an object, such as a human subject, imaging can be performed, using lower energy X-rays (as compared with transmission imaging) to irradiate the object under inspection and generate secondary, scatter X-rays from the object. The scattered X-rays, rather than transmitted X-rays, are then detected to form an image.

Backscatter X-rays have been shown to be useful in imaging human subjects for security screening. For example, American Science & Engineering, Inc. of Billerica, Mass., USA markets a system called BodySearch (™) for this use. The BodySearch system is said to deliver a 5 microrem dose per scan, about 1/6000^{th} that provided by a medical chest X-ray. Rapiscan Security Products, Inc. of Hawthorne, Calif., USA markets a backscatter imaging system known as Secure 1000. It also emits less than 10 microrem per scan.

Both of these products are quite expensive, for a number of reasons. Among those reasons is that both products require moving parts in their X-ray source as they require relative movement between the source and the object being inspected. That is because the source in each instance scans a single line across the object. To form a two-dimensional image, one must translate the source relative to the object, at a steady, controlled rate. Generally, this is achieved by placing the source apparatus on a frame equipped with a mechanism to allow the source to translate transversely to the direction of the scan line swept by an X-ray “pencil” beam. In the BodySearch system 100, illustrated in FIG. 1, it will be seen that the X-ray source includes two moving parts: both a rotating collimator 102 and a vertically translating housing 104. X-rays are emitted via a slit aperture 106 (forming a horizontally scanning pencil beam) toward a person (object) 108 and scattered X-rays are detected by X-ray detectors 110. A resulting image is presented on a screen 112. In FIG. 2, which at 200 shows the Rapiscan Secure 1000 imaging system, the X-ray source also translates vertically within the large cabinet in front of person 202. At 204, an operator views the resulting image on a screen 206. The screen is shown as displaying both front and back images of the person.

In general, the X-rays scattered from a person or similar object under inspection that are scattered back toward the source are referred to as “backscatter.” In contrast, some objects, particularly small objects of crystalline composition, may strongly scatter X-rays away from a direct transmission path, to the sides, at angles from a straight-through path. This is known as “forward scatter.” Crystalline materials exhibit characteristic patterns of forward scatter so it is possible, by detecting such forward scatter and analyzing its pattern, to determine the composition of the crystalline material. Some explosives make use of crystalline materials or other compounds exhibiting characteristic scatter patterns, so a scatter imaging system may have a variety of useful applications.

The presence in prior art scatter imaging systems of a moving source and/or collimator arrangement gives rise to bulk, weight, expense and a need to service the equipment with some frequency and at further expense. A need therefore exists for an X-ray scatter imaging system (backscatter and/or forward scatter) that is effective, yet lower in cost to manufacture and lower in cost to maintain.

### SUMMARY

A scatter radiation system for inspection of objects (non-living, living, or a combination) as discussed herein employs a radiation source and collimator assembly (sometimes referred to simply as a collimated source), preferably with no moving parts (although in one kind of embodiment, the collimated source may be placed on a moving platform). (The reference to “no moving parts” should be understood not to refer to apparatus such as vacuum pumps needed to establish the operating conditions for the X-ray generator but, rather, to parts which would cause the X-ray generator apparatus or associated collimator apparatus to move relative to each other.) In some embodiments, it more particularly requires the absence of movement of the X-ray generator and collimator assembly relative to the object under inspection. Both backscatter and forward scatter detection are possible.

The main type of radiation source discussed herein is an X-ray source but it will be appreciated that an X-ray source is discussed by way of example only and not to the exclusion of other radiation sources which might be substituted.

According to one aspect, a collimated X-ray source is provided that provides a swept line scan of X-rays suitable for backscatter or forward scatter imaging, without using moving parts. X-ray “scanning” has been accomplished by moving the electron beam in a continuous sweep or by sweeping at a series of discrete positions. A succession of scan lines may be used to provide a two-dimensional X-ray illumination of an object. The succession of scan lines may be produced without mechanical movement within the collimated source assembly either with or without mechanical translation of the collimated source relative to the object.

According to another aspect, a system as taught herein includes a scanning, collimated radiation source that electronically (without mechanical moving parts) directs a pencil beam of radiation (e.g., X-rays) in a raster-scan across an object, a scatter radiation detector which produces a signal from detected scattered radiation, and an imaging or analysis system that generates an image from the signal or directly analyzes the signal. Such analysis may include automated decision-making, such as triggering an alarm or initiating a more detailed or higher-powered scan or other analysis based on detecting characteristics that warrant closer attention. A more detailed scan might involve a higher resolution scan of a subsection of the object, for example.

The system may include a collimator disposed between a radiation (e.g., X-ray) generator and the object, and one or more radiation detectors (placed so as to capture backscatter, forward scatter or both types of scatter). As radiation (e.g., X-rays) strike the object, that radiation produces a scatter pattern from the object and the scatter pattern is detected by the detectors. The detected radiation may be processed to form an image of the object as formed by the scatter radiation. The image, or the scatter signals from the detectors, also can be subjected to analysis—e.g., for automatic feature (e.g., composition) identification.

The collimated source assembly may comprise a scanning X-ray generator or other radiation source and a collimator. The collimator may comprise, for example, a shield plate containing a pin-hole aperture. The aperture may be tapered in cross-sectional area. The detectors may include relatively large-area detectors (sensors) such as scintillators and electro-optical scanning equipment (including, e.g., photo-multiplier tubes) for reading the scintillators and producing corresponding electrical signals. The X-ray generator, collimator and sensors may be maintained in stationary positions while scanning an object.

To form an image, the electrical signals from the detectors may be synchronized with the signals that drive the position of the electron beam in the scanning CRT. Synchronization circuits are well known to electrical engineers.

According to another aspect of the invention there is provided a method for scanning an object or material to ascertain its content or composition. Ascertaining content or composition need not require high resolution or great detail, as these are not required in security screening; but the method is adaptable to other uses, as well. A scanning, collimated radiation source having no moving parts emits radiation in the direction of an object to be scanned. Scatter radiation from the object is detected and analyzed or converted to an image of the object.

A typical collimator may be formed from a shield plate with one or more small apertures, placed between the X-ray generator and the object, to control the portion(s) of the object illuminated each instant by the radiation emitted from the generator.

The radiation may be X-radiation or other radiation and it may be generated by a scanning CRT generator.

To increase the X-ray exposure of the object, if a radiation shield is used as a collimator, such shield may be provided with multiple apertures to create a coded aperture, and the resulting signals from the detectors may be suitably superimposed to generate an image of the object.

As yet another alternative, the energy level of the X-ray source may be pulsed, instead of being constant at a given value, to facilitate imaging. Detector signal acquisition can be synchronized with the pulses, reducing the naturally occurring background signal while the average source power remains fixed.

Should it be desired, instead of a 2-D X-ray source, a 1-D source may be employed, together with some mechanical motion (e.g., translation) of the object relative to the source or the source aperture. This arrangement may be employed to obtain, for example, a backscatter image of an object of interest by means of a vertically scanned beam, pinhole collimator and backscatter detector apparatus all mounted on a vehicle or other moving platform. Alternatively, a backscatter image of a moving vehicle could be obtained by employing a stationary vertically scanned beam, pinhole collimator and backscatter detector apparatus.

According to some aspects of the invention, such a 1-D source may comprise an elongated X-ray target and means for scanning an electron beam along the target, the electron beam striking the target at an angle relative to the surface of the target so that X-rays are emitted on the same side of the target but at an angle to the surface of the target.

Other arrangements are disclosed for alternative scanned sources.

The energy signature of the scatter radiation detected by the detectors (e.g., scintillators) may be processed to identify or distinguish among materials in the scanned object.

A scanning beam advantageously is able to be moved rapidly to a desired location. This may be useful for generating forward or backscatter without mechanically moving the x-ray generator. For example, a coherent X-ray scatter system could be built in which a scanning generator is used to direct the beam quickly to a desired position for inspection of the object, perhaps to allow a more detailed inspection of a portion of the object that appears to be of interest. That is, by controlling the scan field, it is possible to examine more closely a portion of the object. Alternatively, the beam may be moved to a series of discrete positions relative to one or more intervening apertures in a collimating device, to generate variously aimed pencil beams. One or more detectors can be positioned to capture the resulting scatter radiation.

### DESCRIPTION OF DRAWINGS

FIG. 1 is a diagrammatic illustration of a first prior art backscatter X-ray system, sold by American Science & Engineering, and utilizing a moving source;

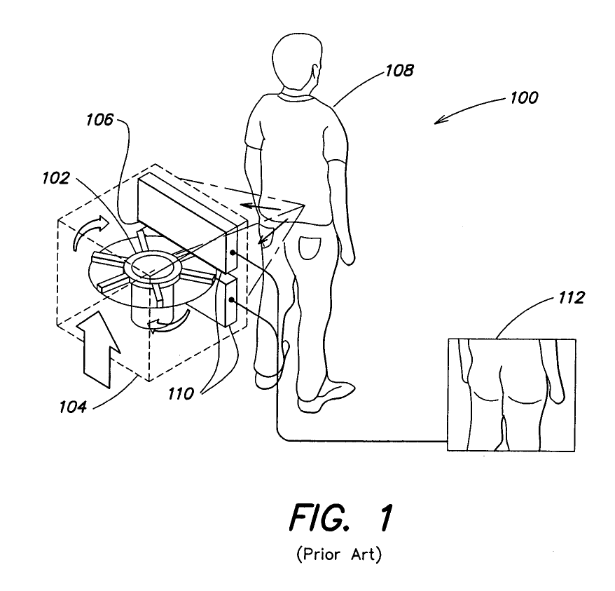

FIG. 2 is a photographic illustration of a second prior art backscatter X-ray system, sold by Rapiscan, and also utilizing a moving source;

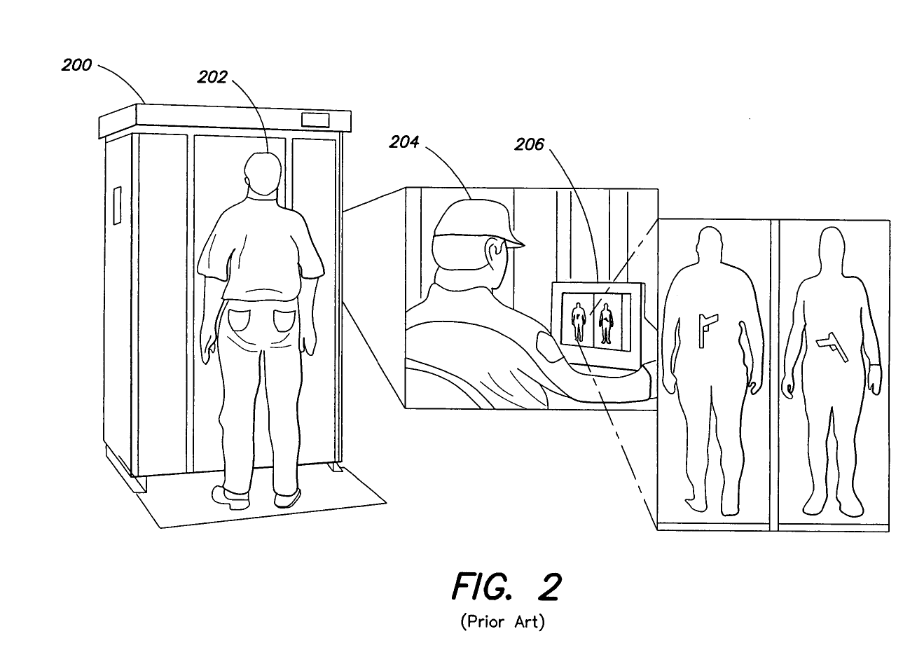

FIG. 3 is a diagrammatic illustration of an example of apparatus and a method according to the disclosed inventive concept and certain embodiments for practicing same; and

FIG. 4 is a diagrammatic example of an alternative 1-D source to the scanning 2-D CRT of FIG. 3.

### DETAILED DESCRIPTION

In the following materials, unless it appears otherwise from the context, X-ray radiation is used as an example of suitable radiation for imaging applications. Such references to X-rays are not intended to preclude use of other types of radiation.

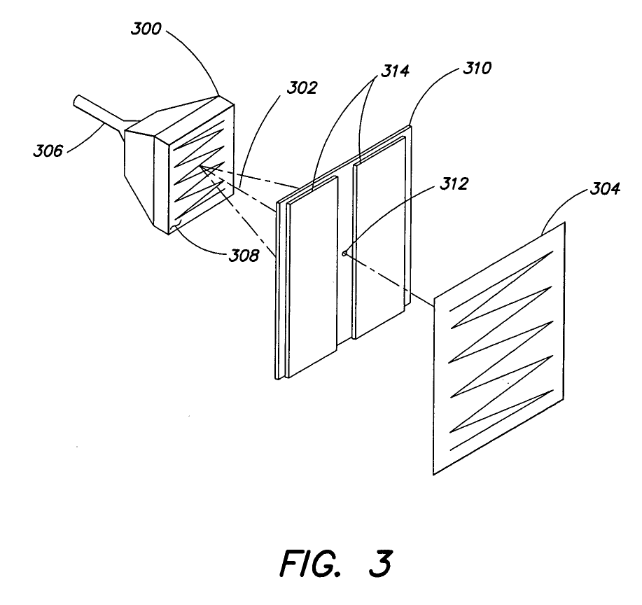

Referring to FIG. 3, an X-ray generator 300 generates X-rays (indicated at 302) toward an object 304 to be imaged. The X-ray generator 300 has no moving parts. For example, it may include a CRT type scanning X-ray source (“X-ray CRT”). The illustrated X-ray source, presented by way of example only, comprises an electron gun 306 that fires a swept electron beam at a target 308 at the front of the source. The target may be thought of as the face of the CRT, though it is inside the glass envelope of the CRT. The target is of an appropriate material, typically a heavy metal such as tungsten or gold, and the electron beam of sufficient energy, such that the electron beam causes the target material to emit X-rays where the beam strikes the target. Thus, as the electron beam is swept across the target in a raster scan, the location of X-ray generation moves correspondingly in space and a swept X-ray source is provided.

The X-ray CRT has a structure generally similar to most cathode ray tubes, such as are used in television sets. However, a cathode ray tube for use in a TV picture tube includes a phosphor screen that emits visible light when struck by an electron beam, rather than a heavy metal target that emits X-rays.

The target must be thick enough to generate X-rays, but not so thick as to prevent the X-rays from coming out of the tube.

When a spot on the target is bombarded by the electron beam from the CRT gun, a cone-shaped X-ray beam 302 is generated. This beam is unfocused and too broad to be useful for imaging purposes. One way to derive a thin beam from this wide beam is to place in front of the X-ray CRT, at an appropriate distance, an X-ray shield (310) such as a lead plate that is provided with a small aperture or pin-hole 312. The pin-hole has a collimating effect with respect to the radiation that passes through it, allowing only a narrow beam to strike the target object. Unfortunately, this approach is not very energy-efficient inasmuch as most of the generated X-ray beam energy is discarded.

On the “downstream” side of the shield plate 310, X-ray detectors 314 are provided, to receive backscatter radiation from the target object. In the illustrated embodiment, which is provided by way of example only, there are two X-ray detectors or sensors. Each sensor receives backscatter X-rays over a significant area (to be contrasted with the point detection of X-rays). As exemplified, those sensors may be plastic scintillator screens or sheets that convert X-rays into visible light, although other kinds of sensors may be employed in addition to or instead of those sensors. Each scintillator screen is optically read by one or more photo-multiplier tubes or other photo detectors (not shown), which then create an electrical signal from the visible light.

The shield, of a material such as lead, not only provides a pin-hole aperture to limit the X-ray beam to a narrow width when it strikes the object, but also prevents X-rays emitted from the CRT source from directly reaching the sensors. Instead, the sensors react only to backscatter X-rays impinging on them from the object, and to background radiation. The entire apparatus must be shielded, of course, except for the side facing the test object or subject, to prevent (or at least bring to an acceptably low level) stray X-ray emission. Shielding is also desirable to reduce the level of background radiation reaching the sensors.

The X-rays emitted by the CRT, from whatever location on the target, only reach the object being scanned (labeled “object”) via the (pin-hole) aperture in the shield plate behind the sensors. So as the electron beam scans the CRT target, a corresponding “pencil-thin” flying spot X-ray beam scans the object, but the scan direction is reversed top-to-bottom and left-to-right.

When the X-rays strike the object, they are either absorbed, pass through the object, are reflected (scattered) off the object, or cause the object to emit secondary X-rays or other radiation, or some combination of the foregoing. The scattered and secondary X-rays, collectively called “scatter,” are detected by the sensors and provide an X-ray signature represented as a time-domain signal from the detectors. That signal is converted into an image on a display based on the information of the position of the flying spot (taken from a corresponding position of the electron beam or, more specifically, the signals controlling its position) and the value of the detector's signal.

In a typical embodiment, the X-ray energy at the CRT may be between about 30 and 450 keV but energies of a few MeV are also possible. The so-called X-ray “flux” or beam current is between about 0.1 mA and 100 mA.

Different materials in the object will generate different amounts of scatter for a given impinging X-ray beam. Thus, different materials will provide different intensity in the detector output signal. The different intensities may be mapped to shades of a monochrome signal or to different color, some combination thereof, or in some other mapping. This property allows visual or algorithmic analysis of the imaging signal to screen objects, sound alarms, etc. For example, the screened object can be a person and the image or analysis can then reveal concealed articles or materials such as guns and plastic explosives, etc. Plastic materials are quite efficient in generating X-ray backscatter.

With multiple, different sensors, it is also possible to perform a spectral analysis of the X-ray scatter and to thereby better discriminate among materials.

If the object being scanned is a person or other living animal, care must be taken, of course, to keep the X-ray dosage level below an amount considered safe. There is a tradeoff between scan speed and the radiation intensity needed to perform satisfactory image generation.

This system, it will be noted, generates back scatter X-ray images without using any moving parts. That translates into improved system reliability and reduced maintenance costs as compared with X-ray scanners that employ moving sources and/or detectors. In the illustrated embodiment, use of a CRT provides a way to generate a 2-D X-ray beam sweep of the object. (Such a scanning CRT X-ray source has been used in the past by, for example, DigiRay, but not for scatter imaging.

It is also possible to use an X-ray source providing only a one-dimensional line-scan sweep and to translate the object relative to the source between successive line-scan sweeps in order to provide an output signal yielding a similar time-domain signal for imaging. While such embodiments do not totally dispense with mechanical motion, they use less than is required by prior art systems. However, to derive positional information from the time-domain signal then requires utilization of both the translational position and the position in the scan line for each received signal value.

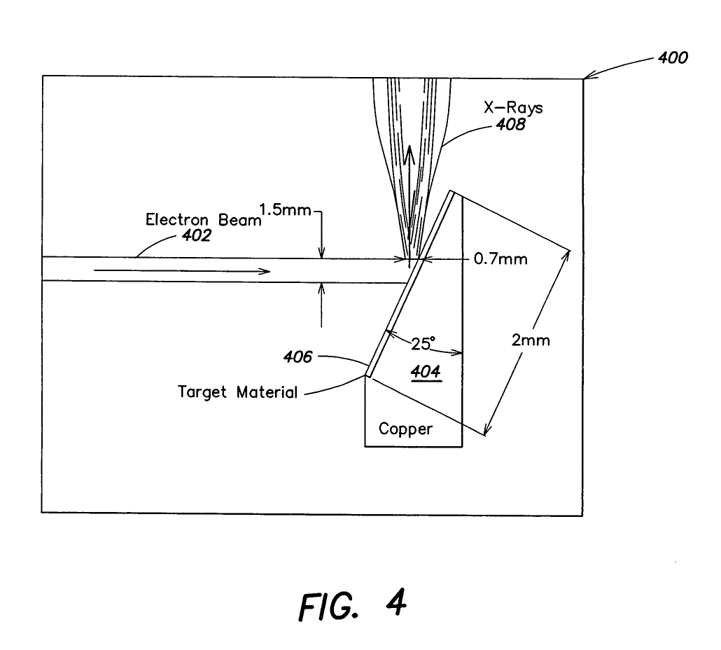

For example, a 1-D scanning source 400 can be made as shown in FIG. 4. There, instead of having the electron beam impact a CRT target that covers a large CRT face area, a 1-D electron beam 402 is scanned along an elongated target 404 (extending into and out of the paper), the surface 406 of the X-ray target being tilted to the beam. The X-rays 408 then emerge at an angle biased relative to the surface of the target, in a line according to the sweep of the electron beam.

A 1-D source also can be constructed using a moving pinhole collimator and a fixed position X-ray generator. Or a moving slit collimator may be employed, disposed at right angles to a fixed slit collimator. Alternatively, the translating, moving slit could be a rotating slit. By contrast, in the AS&E BodySearch system, the collimator is rotated and the source is translated. With the aforementioned arrangement, one need only rotate or translate a collimator, which is still simpler mechanically. This technique might be particularly pertinent to a mobile scanner. With a 1-D scanning source (vertically oriented) and pinhole collimator, the mobile truck motion provides the scanning in the lateral direction.

If the object to be scanned is a person, such that one desires to use a low (e.g., 10 microrem or less) dosage of X-rays, it is challenging to be able to perform a scan in a reasonable time. One approach that provides an acceptable tradeoff at the expense of some image quality and more complex signal processing is to place multiple pinhole apertures in the shield, creating a kind of coded aperture. The images formed from the various pinhole X-ray beams may be superposed through appropriate signal processing. Another approach is to pulse the beam current so that the average X-ray exposure is kept to a desired level but the actual instantaneous exposure level during the pulse interval can be high enough to facilitate good imaging. A pulsed beam could be produced using an X-ray tube or CRT with a grid that can have a variable voltage applied thereto. A still further approach is to increase the “spot” size of the area of X-rays striking the object at a given time. Of course, as spot size increase, image resolution decreases.

The distance between the source and plate, and between the plate and object, and the pinhole aperture size, can be selected to achieve an appropriate imaging area, balanced against having an appropriate radiation intensity striking the object.

It should be appreciated, also, that the same “stationary source” approach may be taken using sources of scattering radiation other than X-rays, along with detectors suitable to the radiation being employed. The concepts discussed herein do not rely on the unique wavelengths of X-rays. Thus, these techniques and the apparatus shown can be adapted to employ other radiation that produces scatter. For example, other radiation in the optical or non-optical regions of the spectrum, like infra red, can be employed if they produce sufficient scatter. The system and method also may be combined with other imaging techniques. For example, the above-described approach may be combined with millimeter wave imaging such as is known or as shown in U.S. Provisional Patent Application Ser. No. 6/579966, titled “MMW Contraband Screening System” and filed Jun. 15, 2004 in the name of Apostle G. Cardiasmenos et al. Or a backscatter system as discussed herein could be combined with a transmission-type of X-ray imaging system. In these mixed systems, one imaging subsystem could be used to provide a “coarse” scan and the other to provide a “fine” scan of a suspicious region, for example.

Among the signal processing that may be performed on the scintillator-detector output signals, one may discriminate automatically among some materials in the object under examination. The intensity of the optical signal read by the detector(s) is a function of the energy of the scattered X-rays. Different materials produce identifiable energy signatures. For example, scatter off metal causes reduced photons, but also a “hardened” (defined) spectrum. Computerized analysis of the energy spectrum can yield probably material identifications, which can be output or displayed in various ways. Alternatively or additionally, an object can be scanned multiple times using, for example, differently pulsed source energy or patterned filtration of the beam, to obtain signature information from comparison of the scatter data.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A scatter radiation system for inspection of objects, comprising a radiation source and beam collimator assembly with no moving parts and providing swept radiation exposure of an object being inspected, and at least one detector of scattered radiation from the object.

2. The system of claim 1, wherein the radiation source provides X-ray radiation.

3. The system of claim 1, wherein the source and collimator assembly is stationary with respect to said object when imaging the object.

4. The system of claim 1, wherein the source and collimator assembly includes a radiation generator and a collimator which are stationary relative to each other and the system further includes means for moving said assembly relative to the object in order to obtain a two-dimensional scan of the object.

5. The system of claim 1 wherein the at least one detector includes at least one detector positioned to receive backscatter radiation from the object.

6. The system of claim 1 wherein the at least one detector includes at least one detector positioned to receive forward scatter radiation from the object.

7. A swept X-ray source and beam collimator assembly that provides a swept scan of X-rays suitable for scatter imaging, without using moving parts.

8. The source of claim 7, further including a deflection apparatus for moving a succession of scan lines to sweep out a two-dimensional X-ray illumination of an object, without moving parts.

9. A system comprising:
a. an electronically scanning radiation source that directs at least one pencil beam of radiation in a raster-scan across an object;
b. at least one radiation detector which detects scatter of said radiation from the object and produces a corresponding signal; and
c. an imaging system that generates an image of the object from the signal.

10. The system of claim 9, wherein the source includes a radiation generator and a radiation shield disposed between the generator and the object, the radiation shield having at least one aperture through which radiation from the source reaches the object.

11. The system of claim 9 or claim 10, wherein the radiation from the radiation source comprises X-radiation.

12. The system of claim 11, wherein the detector includes one or more area-covering radiation detectors.

13. The system of claim 10, wherein the radiation generator is a scanning CRT.

14. The system of claim 13, wherein the detector includes one or more area-covering radiation detectors.

15. The system of claim 10 wherein the radiation shield has multiple apertures through which radiation from the source reach the object, and wherein the imaging system processes signals from said at least one radiation detector to generate an image of the object in response to said radiation reading the object.

16. The system of claim 12 wherein the area-covering detectors include a material or materials that scintillate in response to incident X-rays, and further including means for optically reading the scintillations of said material(s) and producing a corresponding electrical signal.

17. The apparatus of any of claims 1-10 or 15, wherein the radiation source emits pulsed radiation.

18. A method for scanning an object or material to ascertain its content or composition, comprising:
using a scanning radiation source and beam collimation assembly having no moving parts to emit radiation in the direction of an object to be scanned;
detecting radiation scattered from the object and producing a corresponding electrical signal; and
processing the electrical signal to yield an image of the object or analyze the object.

19. The method of claim 18, wherein the scanning radiation source includes an X-ray generator and a radiation collimator placed between the generator and the object to control the portion or portions of the object illuminated each instant by the radiation emitted from the generator.

20. The method of claim 19 wherein the collimator comprises a shield containing one or more apertures through which said radiation passes from the generator to illuminate the object with a pencil beam of radiation.

21. The method of clam 18 or 19 wherein the radiation source is pulsed.
